(19) United States
(12) Patent Application Publication
(10) Pub. No.: US 2015/0315478 A1
(43) Pub. Date: Nov. 5, 2015

(54) SYSTEMS AND METHODS FOR FIELD TREATING HEAVY OR OTHERWISE CHALLENGING CRUDE OILS

(71) Applicants: Patrick Loring Hanks, Bridgewater, NJ (US); Michel Daage, Hellertown, PA (US); Thomas Francis Degnan, JR., Philadelphia, PA (US); Robert Dean Denton, Bellaire, TX (US)

(72) Inventors: Patrick Loring Hanks, Bridgewater, NJ (US); Michel Daage, Hellertown, PA (US); Thomas Francis Degnan, JR., Philadelphia, PA (US); Robert Dean Denton, Bellaire, TX (US)

(73) Assignee: ExxonMobil Research and Engineering Company, Annandale, NJ (US)

(21) Appl. No.: 14/691,900

(22) Filed: Apr. 21, 2015

Related U.S. Application Data
(60) Provisional application No. 61/986,947, filed on May 1, 2014.

(51) Int. Cl. C10G 1/00; C10G 55/02; B01J 19/24; C10G 69/02; B01J 19/00; C10G 1/04; C10G 57/00

(52) U.S. Cl. CPC C10G 1/002; C10G 1/045; C10G 1/00; C10G 55/02; C10G 57/00; C10G 69/02; B01J 19/008; B01J 19/24; B01J 2219/24

(57) ABSTRACT

Systems and methods are provided for improve the rheological properties of heavy crudes, waxy crudes, dilatant crudes and other crudes possessing challenging transporting properties utilizing hydrodynamic cavitation to crack hydrocarbons in the crude oil and thereby improve the transport properties of such crudes.

### CROSS-REFERENCE TO RELATED APPLICATION

The present application claims priority to U.S. Patent Application Ser. No. 61/986,947, filed May 1, 2014.

### FIELD

The present invention relates to the field of treatment of crude oil to render the oil more suitable for transport, such as by pipeline, barge, rail, or tanker. In particular, the present invention relates to methods of treating crude oil and bitumen to improve the physical properties of such materials for transport.

### BACKGROUND

Heavy crude oils and bitumen, due to their high viscosity and other challenging properties, must often be combined with a diluent to reduce the viscosity to acceptable levels for pipeline transport. Because of the possibility that diluent availability could become constrained and there are significant costs associated with providing diluent to remote locations where heavy crude and bitumen are produced and stored, it would be desirable to have other options for reducing the viscosity of such materials for transport, such as via a pipeline, barge, rail, tanker, or combination thereof.

Similarly waxy crudes and dilatant crudes possess rheological properties that pose unique challenges for transporting such crude oils from where they are produced. For example, dilatant crudes produced by offshore platforms may be transported via underwater pipelines for significant distances where the pipeline is exposed to low temperatures. In the event of a temporary shutdown in the flow of dilatant crude through such a pipeline, dilatant oils possess shear-thickening rheological properties which could prevent or challenge the restart of flow through such a pipeline. Waxy crudes pose similar challenges when such crudes are exposed to temperatures below their pour point. It would therefore be desirable to provide methods and systems, particularly those that can be employed in the field to improve the rheological properties of these challenging oils to improve their transport properties.

### SUMMARY

The present invention addresses these and other problems by providing systems and methods which can improve the rheological properties of heavy crudes, waxy crudes, dilatant crudes and other crudes possessing challenging transporting properties to improve the transport properties of such crudes.

In one aspect, a method is provided of improving the properties of a crude oil product for transport. The method includes subjecting a crude oil with a relatively high pour point, such as for example at least 0° C. or a pour point equivalent to or greater than the expected temperature during transport to a refinery, upgrader, chemical manufacturing facility, or a combination thereof, to hydrodynamic cavitation in a hydrodynamic cavitation unit to crack at least a portion of hydrocarbons in the crude oil and thereby produce a cavitated crude oil having a reduced pour point.

In another aspect, a method is provided of improving the properties of a crude oil product for transport. The method includes subjecting a dilatant crude oil to hydrodynamic cavitation in a hydrodynamic cavitation unit to crack at least a portion of the hydrocarbons in the crude oil and thereby produce a cavitated crude oil having a reduced shear-thickening tendency.

In yet another aspect, a method is provided for improving the properties of a crude oil product for transport. The method includes subjecting a mixture of water and bitumen to a paraffin froth treatment; and subjecting at least a portion of the bitumen treated by the paraffin froth treatment to hydrodynamic cavitation in a hydrodynamic cavitation unit to crack at least a portion of hydrocarbons in the bitumen and thereby produce a cavitated bitumen product.

In yet another aspect, a system is provided for improving the properties of a crude oil product for transport. The system includes a mixed bitumen and water feed; a paraffin froth treatment receiving the mixed bitumen and water feed; and a hydrodynamic cavitation unit downstream of the paraffin froth treatment that is adapted to crack at least a portion of hydrocarbons in the bitumen and thereby produce a cavitated bitumen product.

### BRIEF DESCRIPTION OF THE DRAWINGS

FIG. 1 is a cross section view of an exemplary hydrodynamic cavitation unit, which may be employed in one or more embodiments of the present invention.

FIG. 2 is a flow diagram of a system for preparing a heavy feed for pipeline transport according to one or more embodiments of the present invention.

FIG. 3 is a flow diagram of a system for preparing oil sands product for pipeline transport according to one or more embodiments of the present invention.

### DETAILED DESCRIPTION

Systems and methods are disclosed herein which can improve the rheological properties of heavy crudes, waxy crudes, dilatant crudes and other crudes possessing challenging transporting properties.

Methods and systems are provided for improving the properties of heavy oil products, and other challenging crudes, to reduce the need for diluents when transporting such heavy oil products via a pipeline, barge, rail, or tanker. Advantageously, such systems may be deployed and integrated at locations where heavy oil products are produced or stored, e.g. locations that are geographically remote from where such products are to be refined. Having been improved by the methods and systems disclosed herein, the products may then be transported over significant distances (such as greater than 10 miles, 100 miles, 500 miles, or 1000 miles) via pipelines, rail, barge, tanker, or a combination thereof to a refinery. In addition, by integrating such units at locations the product is produced or stored, a higher value product that is easier for refineries to produce may also be produced.

Applicable feeds include heavy hydrocarbon feeds such full range heavy crude oils, including bitumen and oil sand products. The methods disclosed herein are particularly useful for various types of crudes that pose challenges for pipeline or other transport, including heavy crudes, waxy crudes, dilatant crudes and others. Furthermore, the methods disclosed herein are particularly useful for deployment in the production field, on offshore platforms, and where oil is stored.

The term “heavy crude” as used herein refers to crude oils having an API gravity of 22° or less. The methods are particularly useful for heavy crudes having an API gravity of 20° or less, or 18° or less, or 15° or less, or 10° or less. Such crudes may include oil sands crude and bitumen, such as those to be treated with paraffin froth treatment. The term “paraffin froth treatment” as used herein refers to a process whereby a paraffinic solvent, such as n-pentane, iso-pentane, or combinations thereof, is added to bitumen at a solvent-to-bitumen ratio that is effective for formation of aggregates composed of emulsified water droplets, mineral solid particles and precipitated asphaltenes. Other paraffin streams comprised of 5-7 carbon atoms are also useful in paraffin froth treatment.

The term “waxy crude” as used herein refers to crudes have a high relative wax content often indicated by an elevated pour point. For example, such crudes may have a wax content of at least 5 wt %, or at least 7 wt %, or at least 10 wt %. The pour point, as determined by ASTM D5853, of such crudes may be greater than 0° C., or greater than 5° C., or greater than 10° C. Such crudes may have any API gravity; however, the methods disclosed herein may be particularly useful for waxy crudes having an API gravity of 25° or more, or more preferably 30° or more. Advantageously, the methods disclosed herein may result in the preferential cracking of long chain paraffins present in the waxy crude, reducing the pour point of the waxy crude and thereby improving its properties for transport.

The term “dilatant oil” as used herein refers to crudes and other oils having shear thickening non-Newtonian fluid properties. The methods disclosed herein are particularly useful for dilatant oils that are produced on offshore oil platforms and dilatant oils that are transported over pipelines exposed to relatively low ambient temperatures. Treatment of such dilatant oils may reduce the oil's shear-thickening tendencies.

As described herein, a method is provided for improving the properties of any one or more of the aforementioned challenging oils for transport. The method includes subjecting such an oil to hydrodynamic cavitation to crack at least a portion of hydrocarbons in the oil and thereby produce a cavitated oil product, and thereafter transporting the cavitated oil product via a pipeline or other form of transport. In any embodiment, a separator may be employed downstream of the hydrodynamic cavitation unit and upstream of the pipeline. The separator may be any kind of separator including, but not limited to, a settling vessel, a flash vessel, a distillation column, a steam stripper or a combination thereof. The separator may separate lighter product from the cavitated product stream to reduce or avoid asphaltene precipitation in the pipeline. In any embodiment, at least a portion of the heavier product from cavitated product stream may be refluxed to mix with the heavy oil feed stream and be fed through the hydrodynamic cavitation unit again.

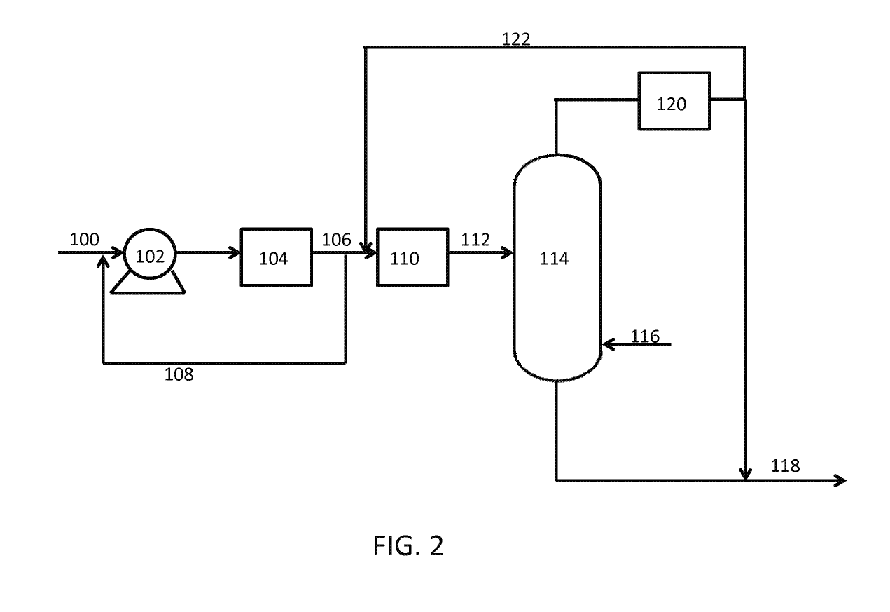

An exemplary embodiment of a system and method for improving the properties of an oil for pipeline transport is illustrated in FIG. 2. An oil feed 100, which may be any of the feeds described herein, is transported via pump 102 to hydrodynamic cavitation unit 104 under conditions suitable for hydrodynamically cavitating the feed 100 and thereby crack at least a portion of the hydrocarbons in the feed and produce a cavitated feed stream 106. Specific aspects and details of the hydrodynamic cavitation unit 104 is described in greater detail subsequently. In any embodiment, the feed 100 may be fed to hydrodynamic cavitation unit 104 at a temperature of about 150° F. to 210° F., and the feed 100 may be subjected to a pressure drop of about 1500 psi to about 2500 psi, or about 2,000 psi passing through the hydrodynamic cavitation unit 104.

Cavitated feed stream 106 may then be fed to a second hydrodynamic cavitation unit 110 for additional cavitation of the cavitated feed stream 106. A portion of the cavitated feed stream 106 may also be refluxed as stream 108 and mixed with feed stream 100 upstream of the hydrodynamic cavitation unit 104. In the second hydrodynamic cavitation unit 110, hydrocarbon molecules may be cracked into smaller hydrocarbons. The conditions of hydrodynamic cavitation may be the same or different than as in the first hydrodynamic cavitation unit 104, and the general conditions for hydrodynamic cavitation are described in greater detail subsequently.

The cavitated stream 112 exiting the hydrodynamic cavitation unit 110 may then be fed to a separator 114 for separating lighter and heavier portions of the cavitated stream 112. The separator 114 may be a flash vessel, a distillation column, a stream stripper or a combination thereof. Steam, or other stripping gases such as methane, 116 may be fed to the separator 114 to facilitate separation. Lighter product may be recovered out the top. In any embodiment, the recovered light product may be hydrotreated in a hydrotreatment unit 120 to remove sulfur, nitrogen, or olefins from the feed. The hydrotreated product stream may then be mixed with the heavier portion of the cavitated stream 112 to form a product stream 118 or may be utilized in a separate process. A portion of the lighter fraction, once hydrotreated, may be refluxed as stream 122 upstream of one or both hydrodynamic cavitation units 110 and 104. The product stream 118 may then be transported via pipeline, such as to a refinery for further processing.

Although not illustrated, it should be appreciated that additional pumps may be employed to increase fluid pressure as required to establish conditions suitable for operation of the individual process units described herein. Furthermore, heat exchangers may be employed to heat or cool the liquid, to modify vapor pressure and viscosity of the fluid as required or desired. In addition, other vapor-liquid separation devices may be employed to remove light ends to modify vapor pressure and the amount of dissolved gas in the liquid. The term “light ends” as used herein refers to C4 and lighter gases including all isomers and olefins, H₂, CO, CO₂, H₂S, N₂, NH₃, etc. This may be particularly useful for controlling the number of cavitation events or event intensity.

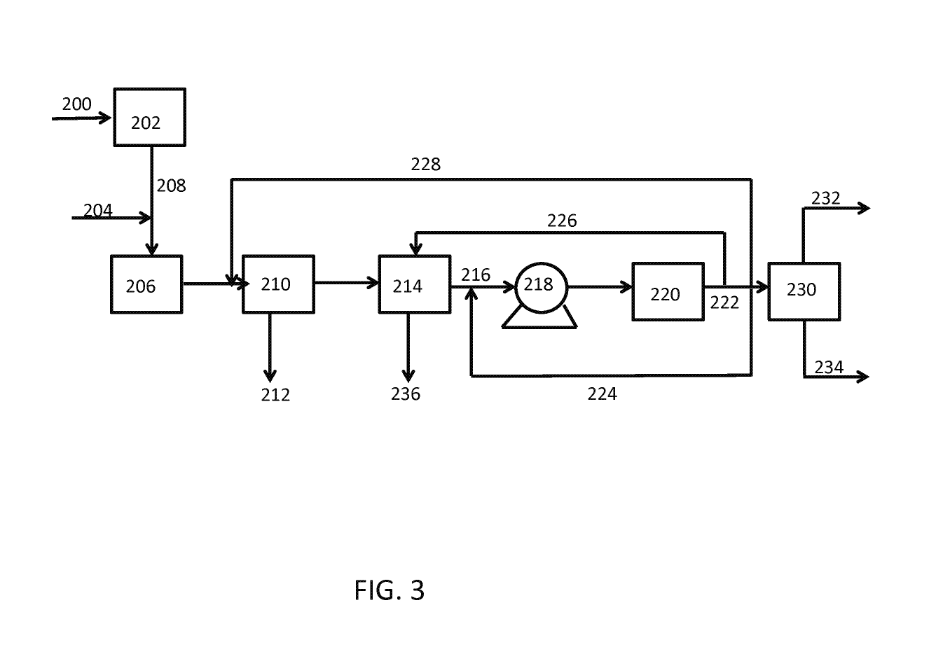

The integration of the disclosed methods and systems with an oil sands operation is illustrated in FIG. 3. In such an embodiment, an oil sands product feed 200, such as bitumen, is fed to a crusher 202 to produce a crushed product 208. Water 204 is added to the crushed product to facilitate hydrotransport 206 of the crushed product 208 to an extraction unit 210. The extraction unit 210 may include one or more settling vessels and/or floatation cells to separate sand and water 212 from the product. The resulting froth may then be fed to a paraffin froth treatment unit 214, optionally after passing through a deaerator (not shown).

Within the paraffin froth treatment unit 214, at least a portion of the water and waste materials (e.g., fines and asphaltenes) are removed from the product via stream 236. Naphtha and/or paraffinic solvents may be used in the paraffin froth treatment unit 214 to facilitate the separation. The paraffin froth treatment unit 214 may include one or more settling units in which solvent and bitumen are separated from the fines, water, and asphaltenes. The bottom product of one or more settling units may be fed to a tailing solvent recovery unit for separation of solvent from the fines, water, and asphaltenes. The recovered solvent may be recycled to the settling units. The top product from the settling units may also be sent to a solvent recovery unit for recovering solvent from the product stream 216.

The product stream 216 from the paraffin froth treatment unit 214 may be fed via a pump 218 to a hydrodynamic cavitation unit 220 at a temperature and pressure suitable for hydrodynamically cavitating the product stream 216, and thereby cracking at least a portion of the hydrocarbons in the product stream 216. In any embodiment, the hydrodynamic cavitation unit 220 is operated at conditions suitable for dealkylating side chains from at least a portion of the asphaltene molecules remaining in the product stream 216 after the paraffin forth treatment unit 214. Additional aspects of the hydrodynamic cavitation unit 220 is described in greater detail herein subsequently.

The cavitated product stream 222 may be sent to a vapor-liquid separator 230 to separate light ends 232 produced in the process for fuel gas. In cases where there is concern of naphtha range olefins causing gumming, the naphtha portion may also be separated and used for fuel or sent to a diolefin saturator before being blended with the product feed 234 and fed into the pipeline for transport, e.g., to a refinery.

Portions of the cavitated product stream 222 may be recycled to other upstream stages of the process as illustrated in FIG. 3. For example, reflux stream 224 may be recycled to the suction side of pump 218 to improve the performance of the hydrodynamic cavitation unit 220.

In addition, or in the alternative, a portion of the cavitated product stream 222 may be refluxed via stream 226 to the paraffin froth treatment unit 214, where it is mixed with product in the settling tanks. In such a case, the induced asphaltenes caused by dealkylation of side chains may be rejected into the tailings stream and removed via stream 236. These induced asphaltenes are largely aromatic cores that are too hydrogen deficient to make transportation fuels and have poor asphaltene qualities. There are many other advantages that may be realized by refluxing a portion of the cavitated product 222 to the paraffin froth treatment unit 214. For example, such a process may produce a lower viscosity product as additional large molecules that contribute to increased viscosity are removed. These induced asphaltenes also contain Conradson carbon residue (CCR) and metals that may be removed from the oil in the paraffin froth treatment unit 214, resulting in a crude oil that is easier for refineries to process. Such a process also can result in additional stage of cracking for the portion that is refluxed, leading to further reduction in viscosity. Such a process, can also yield a product with a higher hydrogen to carbon ratio than if stream 226 was omitted. Furthermore, the precipitation of induced asphaltenes may allow for a lower solvent to oil ratio at constant product particulate concentration.

In addition, or in the alternative, a portion of the cavitated product stream 222 may be refluxed via stream 228 to the ore preparation and extraction processes of the facility. In such a case, the hydrotransport process 206 may break down solids aggregates and dissolve some portion of the bitumen. Bitumen that absorbs to the sand may more readily dissolve in a cavitated product and water mixture, resulting in an increase yield per ton of ore extracted.

Advantageously, the systems disclosed herein, including separators/fractionators, scrubbers, hydrotreaters and the like may be employed entirely or in part in the field where the crude is produced and/or stored prior to transport, i.e., outside of a refinery. For example, light ends or naphtha separated from the cavitated product may be used as a fuel source to support operations in the field.

### Hydrodynamic Cavitation Unit

The term “hydrodynamic cavitation”, as used herein refers to a process whereby fluid undergoes convective acceleration, followed by pressure drop and bubble formation, and then convective deceleration and bubble implosion. The implosion occurs faster than most of the mass in the vapor bubble can transfer to the surrounding liquid, resulting in a near adiabatic collapse. This generates extremely high localized energy densities (temperature, pressure) capable of dealkylation of side chains from large hydrocarbon molecules, creating free radicals and other sonochemical reactions.

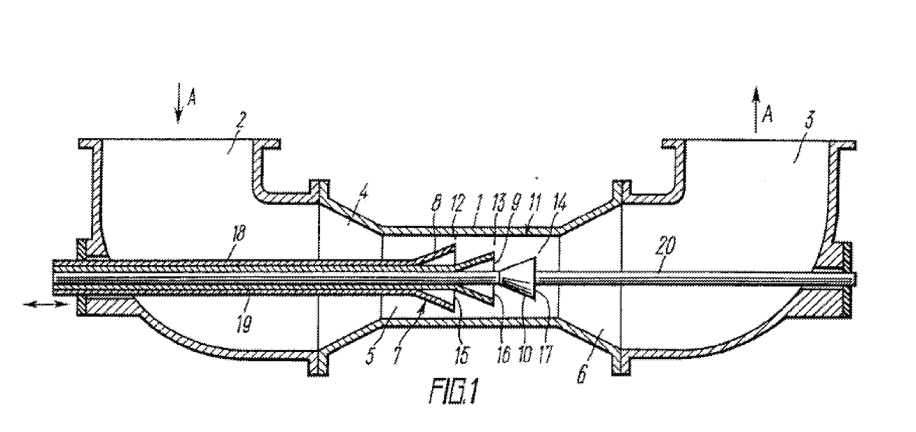

The term “hydrodynamic cavitation unit” refers to one or more processing units that receive a fluid and subject the fluid to hydrodynamic cavitation. In any embodiment, the hydrodynamic cavitation unit may receive a continuous flow of the fluid and subject the flow to continuous cavitation within a cavitation region of the unit. An exemplary hydrodynamic cavitation unit is illustrated in FIG. 1. Referring to FIG. 1, there is a diagrammatically shown view of a device consisting of a housing I having inlet opening 2 and outlet opening 3, and internally accommodating a contractor 4, a flow channel 5 and a diffuser 6 which are arranged in succession on the side of the opening 2 and are connected with one another. A cavitation region defined at least in part by channel 5 accommodates a baffle body 7 comprising three elements in the form of hollow truncated cones 8, 9, 10 arranged in succession in the direction of the flow and their smaller bases are oriented toward the contractor 4. The baffle body 7 and a wall 11 of the flow channel 5 form sections 12, 13, 14 of the local contraction of the flow arranged in succession in the direction of the flow and shaving the cross-section of an annular profile. The cone 8, being the first in the direction of the flow, has the diameter of a larger base 15 which exceeds the diameter of a larger base 16 of the subsequent cone 9. The diameter of the larger base 16 of the cone 9 exceeds the diameter of a larger base 17 of the subsequent cone 10. The taper angle of the cones 8, 9, 10 decreases from each preceding cone to each subsequent cone.

The cones may be made specifically with equal taper angles in an alternative embodiment of the device. The cones 8, 9, 10 are secured respectively on rods 18, 19, 20 coaxially installed in the flow channel 5. The rods 18, 19 are made hollow and are arranged coaxially with each other, and the rod 20 is accommodated in the space of the rod 19 along the axis. The rods 19 and 20 are connected with individual mechanisms (not shown in FIG. 1) for axial movement relative to each other and to the rod 18. In an alternative embodiment of the device, the rod 18 may also be provided with a mechanism for movement along the axis of the flow channel 5. Axial movement of the cones 8, 9, 10 makes it possible to change the geometry of the baffle body 7 and hence to change the profile of the cross-section of the sections 12, 13, 14 and the distance between them throughout the length of the flow channel 5 which in turn makes it possible to regulate the degree of cavitation of the hydrodynamic cavitation fields downstream of each of the cones 8, 9, 10 and the multiplicity of treating the components. For adjusting the cavitation fields, the subsequent cones 9, 10 may be advantageously partly arranged in the space of the preceding cones 8, 9; however, the minimum distance between their smaller bases should be at least equal to 0.3 of the larger diameter of the preceding cones 8, 9, respectively. If required, one of the subsequent cones 9, 10 may be completely arranged in the space of the preceding cone on condition of maintaining two working elements in the baffle body 7. The flow of the fluid under treatment is show by the direction of arrow A.

Hydrodynamic cavitation units of other designs are known and may be employed in the context of the inventive systems and processes disclosed herein. For example, hydrodynamic cavitation units having other geometric profiles are illustrated and described in U.S. Pat. No. 5,492,654, which is incorporated by reference herein in its entirety. Other designs of hydrodynamic cavitation units are described in the published literature, including but not limited to U.S. Pat. Nos. 5,937,906; 5,969,207; 6,502,979; 7,086,777; and 7,357,566, all of which are incorporated by reference herein in their entirety.

In an exemplary embodiment, conversion of hydrocarbon fluid is achieved by establishing a hydrodynamic flow of the hydrodynamic fluid through a flow-through passage having a portion that ensures the local constriction for the hydrodynamic flow, and by establishing a hydrodynamic cavitation field (e.g., within a cavitation region of the cavitation unit) of collapsing vapor bubbles in the hydrodynamic field that facilitates the conversion of at least a part of the hydrocarbon components of the hydrocarbon fluid.

For example, a hydrocarbon fluid may be fed to a flow-through passage at a first velocity, and may be accelerated through a continuous flow-through passage (such as due to constriction or taper of the passage) to a second velocity that may be 3 to 50 times faster than the first velocity. As a result, in this location the static pressure in the flow decreases, for example from 1-20 kPa. This induces the origin of cavitation in the flow to have the appearance of vapor-filled cavities and bubbles. In the flow-through passage, the pressure of the vapor hydrocarbons inside the cavitation bubbles is 1-20 kPa. When the cavitation bubbles are carried away in the flow beyond the boundary of the narrowed flow-through passage, the pressure in the fluid increases.

This increase in the static pressure drives the near instantaneous adiabatic collapsing of the cavitation bubbles. For example, the bubble collapse time duration may be on the magnitude of 10⁻⁶ to 10⁻⁸ second. The precise duration of the collapse is dependent upon the size of the bubbles and the static pressure of the flow. The flow velocities reached during the collapse of the vacuum may be 100-1000 times faster than the first velocity or 6-100 times faster than the second velocity. In this final stage of bubble collapse, the elevated temperatures in the bubbles are realized with a velocity of 10¹⁰-10¹² K/sec. The vaporous/gaseous mixture of hydrocarbons found inside the bubbles may reach temperatures in the range of 1500-15,000K at a pressure of 100-1500 MPa. Under these physical conditions inside of the cavitation bubbles, thermal disintegration of hydrocarbon molecules occurs, such that the pressure and the temperature in the bubbles surpasses the magnitude of the analogous parameters of other cracking processes. In addition to the high temperatures formed in the vapor bubble, a thin liquid film surrounding the bubbles is subjected to high temperatures where additional chemistry (e.g., thermal cracking of hydrocarbons and dealkylation of side chains) occurs. The rapid velocities achieved during the implosion generate a shockwave that can: mechanically disrupt agglomerates (such as asphaltene agglomerates or agglomerated particulates), create emulsions with small mean droplet diameters, and reduce mean particulate size in a slurry.

### Specific Embodiments

To further illustrate different aspects of the present invention, the following specific embodiments are provided:

Paragraph A—A method of improving the properties of a crude oil product for transport comprising: subjecting a crude oil with a pour point of at least 0° C. to hydrodynamic cavitation in a hydrodynamic cavitation unit to crack at least a portion of hydrocarbons in the crude oil and thereby produce a cavitated crude oil having a reduced pour point.

Paragraph B—A method of improving the properties of a crude oil product for transport comprising: subjecting a dilatant crude oil to hydrodynamic cavitation in a hydrodynamic cavitation unit to crack at least a portion of the hydrocarbons in the crude oil and thereby produce a cavitated crude oil having a reduced shear-thickening tendency.

Paragraph C—A method for improving the properties of a crude oil product for transport comprising: subjecting a mixture of water and a crude oil, such as bitumen, to a paraffin froth treatment; and subjecting at least a portion of the crude oil (e.g., bitumen) treated by the paraffin forth treatment to hydrodynamic cavitation in a hydrodynamic cavitation unit to crack at least a portion of hydrocarbons in the crude oil (e.g., bitumen) and thereby produce a cavitated crude oil (e.g., bitumen) product.

Paragraph D—The method Paragraph C, wherein at least a portion of the cavitated crude oil (bitumen) is recycled to the paraffin froth treatment.

Paragraph E—The method of Paragraph C or D, wherein at least a portion of the cavitated crude oil (bitumen) is recycled upstream of the paraffin froth treatment.

Paragraph F—The method of any of Paragraphs A-E, further comprising transporting the cavitated crude oil to a refinery.

Paragraph G—The method of Paragraph F, wherein the cavitated crude oil is transported via a pipeline, a barge, a railcar, a tanker, or a combination thereof.

Paragraph H—The method of any of Paragraphs A-G, wherein the crude oil has an API gravity of 30° or greater.

Paragraph I—The method of any of Paragraphs A-H, wherein when the crude oil is subjected to hydrodynamic cavitation, a portion of the hydrocarbons in the crude oil are converted to lower molecular weight hydrocarbons.

Paragraph J—The method of Paragraph I, wherein 1 to 35 wt % of a 1050+° F. boiling point fraction of the crude oil are converted to lower molecular weight hydrocarbons.

Paragraph K—The method of any of Paragraphs A-J, wherein the crude oil is subjected to a pressure drop of at least 400 psig, or more preferably greater than 1000 psig, or more preferably greater than 2000 psig when subjected to hydrodynamic cavitation.

Paragraph L—The method of any of Paragraphs A-K, wherein the crude oil is fed to the hydrodynamic cavitation unit at a temperature between about 150° F. and about 450° F.

Paragraph M—The method of Paragraph L, wherein the temperature is between about 150° F. and about 200° F.

Paragraph N—The method of any of Paragraphs A-M, wherein at least a portion of the cavitated crude oil is recycled back to the cavitation unit.

Paragraph O—The method of any of Paragraphs A-N, further comprising stripping at least a portion of light ends and dissolved gases from the cavitated crude oil.

Paragraph P—The method of Paragraph O, further comprising scrubbing the light ends and dissolved gases to remove at least a portion of acid gas (i.e., a gas containing H₂S or CO2) components contained therein.

Paragraph Q—The method of Paragraph P, wherein the scrubbed light ends and dissolved gases are used as a fuel gas.

Paragraph R—The method of any of Paragraphs A-Q, further comprising separating a naphtha fraction from the cavitated crude oil.

Paragraph S—The method of Paragraph R, further comprising hydrotreating the naphtha fraction to reduce unsaturation, as indicated by the bromine number measured by ASTM D1159.

Paragraph T—The method of Paragraph S, further comprising blending the hydrotreated naphtha back in to the cavitated crude.

Paragraph U—The method of any of Paragraphs A-T, wherein the hydrodynamic cavitation is performed in the absence of a catalyst.

Paragraph V—The method of any of Paragraphs A-U, wherein the hydrodynamic cavitation is performed in the absences of a diluent oil or free water.

Paragraph W—The method of any of Paragraphs A-V, wherein the hydrodynamic cavitation is performed in the absence of hydrogen gas or wherein hydrogen gas is present at less than 50 standard cubic feet per barrel.

Paragraph X—The method of any of Paragraphs A-W, wherein the cavitated crude oil has a viscosity that is at least 10% reduced, more preferably at least 15% reduced, more preferably at least 20% reduced, or more preferably at least 30% reduced at 40° C. or 100° C., as measured by ASTM D445, compared to the crude oil.

Paragraph Y—The method of any of Paragraphs A-X, wherein the cavitated crude oil has a pour point that is at reduced by at least 1° C., more preferably at least 2° C., more preferably at least 3° C., more preferably at least 4° C., more preferably at least 5° C., or more preferably at least 10° C., even more preferably at least 20° C. or at least 30° C. relative to the crude oil as measured by ASTM D5853.

Paragraph Z—The method of any of Paragraphs A-Y, wherein the method is performed partially or entirely in a field where the crude oil is produced.

Paragraph AA—The method of any of Paragraphs A-Z, wherein the method is performed offshore.

Paragraph BB—The method of any of Paragraphs A-Z or AA, wherein the method is performed on an offshore platform

Paragraph CC—A product of the method of any of Paragraphs A-Z or AA-BB.

Paragraph DD—A system adapted to perform the method of any of Paragraphs A-Z or AA-BB.

Paragraph EE—A system for improving the properties of a crude oil product for transport comprising: a mixed bitumen and water feed; a paraffin froth treatment receiving the mixed bitumen and water feed; and a hydrodynamic cavitation unit downstream of the paraffin froth treatment that is adapted to crack at least a portion of hydrocarbons in the bitumen and thereby produce a cavitated bitumen product.

What is claimed is:

1. A method of improving the properties of a crude oil product for transport comprising:
subjecting a crude oil with a pour point of at least 0° C., a wax content of at least 5 wt %, or a combination thereof to hydrodynamic cavitation in a hydrodynamic cavitation unit to crack at least a portion of hydrocarbons in the crude oil and thereby produce a cavitated crude oil having a reduced pour point.

2. The method of claim 1, further comprising transporting the cavitated crude oil to a refinery, upgrader, a chemical manufacturing facility or a combination thereof.

3. The method of claim 2, wherein the cavitated crude oil is transported via a pipeline, a barge, a railcar, a tanker, or a combination thereof.

4. The method of claim 1, wherein the crude oil has an API gravity of 30° or greater.

5. The method of claim 1, wherein when the crude oil is subjected to hydrodynamic cavitation, a portion of the hydrocarbons in the crude oil are converted to lower molecular weight hydrocarbons.

6. The method of claim 5, wherein 1 to 35 wt % of a 1050+° F. boiling point fraction of the crude oil are converted to lower molecular weight hydrocarbons.

7. The method of claim 1, wherein the crude oil is subjected to a pressure drop of at least 400 psig when subjected to hydrodynamic cavitation.

8. The method of claim 7, wherein the pressure drop is greater than 1000 psig.

9. The method of claim 8, wherein the pressure drop is greater than 2000 psig.

10. The method of claim 1, wherein the crude oil is fed to the hydrodynamic cavitation unit at a temperature between about 150° F. and about 450° F.

11. The method of claim 10, wherein the temperature is between about 150° F. and about 200° F.

12. The method of claim 1, wherein at least a portion of the cavitated crude oil is recycled back to the cavitation unit.

13. The method of claim 1, further comprising stripping at least a portion of light ends and dissolved gases from the cavitated crude oil.

14. The method of claim 13, further comprising scrubbing the light ends and dissolved gases to remove at least a portion of acid gas components contained therein.

15. The method of claim 14, wherein the scrubbed light ends and dissolved gases are used as a fuel gas.

16. The method of claim 1, further comprising separating a naphtha fraction from the cavitated crude oil.

17. The method of claim 16, further comprising hydrotreating the naphtha fraction to reduce unsaturation.

18. The method of claim 17, further comprising blending the hydrotreated naphtha back in to the cavitated crude.

19. The method of claim 1, wherein the hydrodynamic cavitation is performed in the absence of a catalyst.

20. The method of claim 1, wherein the hydrodynamic cavitation is performed in the absences of a diluent oil or free water.

21. The method of claim 1, wherein the cavitated crude oil has a viscosity as measured at 40° C. in accordance with ASTM D445 that is at least 10% reduced compared to the crude oil.

22. The method of claim 1, wherein the hydrodynamic cavitation is performed in the absence of hydrogen gas or wherein hydrogen gas is present at less than 50 standard cubic feet per barrel.

23. The method of claim 1, wherein the cavitated crude oil has a pour point that is reduced by at least 1° C. compared to the crude oil as determined by ASTM D5853.

24. A product of the method of claim 1.

25. A method for improving the properties of a crude oil product for transport comprising:
subjecting a mixture of water and bitumen to a paraffin froth treatment; and
subjecting at least a portion of the bitumen treated by the paraffin forth treatment to hydrodynamic cavitation in a hydrodynamic cavitation unit to crack at least a portion of hydrocarbons in the bitumen and thereby produce a cavitated bitumen product.

26. The method of claim 25, further comprising transporting the cavitated bitumen product to a refinery, an upgrader, a chemical manufacturing facility, or a combination thereof.

27. The method of claim 26, wherein the cavitated bitumen product is transported via a pipeline, a barge, a railcar, a tanker, or a combination thereof.

28. The method of claim 25, wherein when the bitumen is subjected to hydrodynamic cavitation, a portion of the hydrocarbons in the bitumen are converted to lower molecular weight hydrocarbons.

29. The method of claim 28, wherein 1 to 35 wt % of a 1050+° F. boiling point fraction of the bitumen converted to lower molecular weight hydrocarbons.

30. The method of claim 25, wherein the bitumen is subjected to a pressure drop of at least 400 psig when subjected to hydrodynamic cavitation.

31. The method of claim 30, wherein the pressure drop is greater than 1000 psig.

32. The method of claim 31, wherein the pressure drop is greater than 2000 psig.

33. The method of claim 25, wherein the bitumen is fed to the hydrodynamic cavitation unit at a temperature between about 150° F. and about 450° F.

34. The method of claim 25, wherein at least a portion of the cavitated bitumen is recycled back to the cavitation unit.

35. The method of claim 25, wherein at least a portion of the cavitated bitumen is recycled to the paraffin froth treatment.

36. The method of claim 25, wherein at least a portion of the cavitated bitumen is recycled upstream of the paraffin froth treatment.

37. The method of claim 25, further comprising stripping at least a portion of light ends and dissolved gases from the cavitated bitumen.

38. The method of claim 37, further comprising scrubbing the light ends and dissolved gases to remove at least a portion of acid gas components contained therein.

39. The method of claim 38, wherein the scrubbed light ends and dissolved gases are used as a fuel gas.

40. The method of claim 25, further comprising separating a naphtha fraction from the cavitated bitumen.

41. The method of claim 40, further comprising hydrotreating the naphtha fraction to reduce unsaturation.

42. The method of claim 40, further comprising blending the hydrotreated naphtha back in to the bitumen.

43. The method of claim 25, wherein the hydrodynamic cavitation is performed in the absence of a catalyst.

44. The method of claim 25, wherein the hydrodynamic cavitation is performed in the absences of a diluent oil or water.

45. The method of claim 25, wherein the cavitated bitumen has a viscosity as measured at 40° C. in accordance with ASTM D445 that is at least 10% less than the bitumen.

46. A product of the method of claim 25.

47. A system for improving the properties of a crude oil product for transport comprising:
a mixed bitumen and water feed;
a paraffin froth treatment unit receiving the mixed bitumen and water feed; and
a hydrodynamic cavitation unit downstream of the paraffin froth treatment that is adapted to crack at least a portion of hydrocarbons in the bitumen and thereby produce a cavitated bitumen product.
